(19) United States
(12) Patent Application Publication
(10) Pub. No.: US 2014/0123250 A1
(43) Pub. Date: May 1, 2014

(54) SECURITIZATION OF DEVELOPER CREDENTIALS

(71) Applicant: JEAN-JACQUES DUBRAY, BELLEVUE, WA (US)

(72) Inventor: Jean-Jacques Dubray, Bellevue, WA (US)

(73) Assignee: EMPIRE TECHNOLOGY DEVELOPMENT, LLC, Wilmington, DE (US)

(21) Appl. No.: 13/819,242

(22) PCT Filed: Oct. 26, 2012
(86) PCT No.: PCT/US2012/062072

§ 371 Date: Feb. 26, 2013

(51) Int. Cl. H04L 29/06

(52) U.S. Cl. CPC H04L 63/10
USPC 726/5

(57) ABSTRACT

Technologies are generally described for systems and methods configured to provide developer credentials to a device. In some examples, a developer device may be configured to send a registration request relating to a program to a service server. In response, the developer device may receive first information. A processor in a user device may be configured to store the program and the first information. The processor may execute at least part of the program to send a first request, including the first information, to a platform server. The processor may be further configured to receive second information in response. The processor may execute the program using the first and second information to generate a second request. The second request may include the second information and may be sent to a service server different from the platform server.

### BACKGROUND

Unless otherwise indicated herein, the materials described in this section are not prior art to the claims in this application and are not admitted to be prior art by inclusion in this section.

A software program may be generated by a developer. The developer may store the program in a memory, such as an application store, so that the program may be available to be copied or transferred. Users may access and copy the program to a computing device such as a computer, mobile phone, mobile device, tablet etc. Some developers generate programs that use services provided by other parties.

### SUMMARY

In one example, a device configured to receive developer credentials for a program is generally described. The device may include a memory and a processor configured to be in communication with the memory. The processor may be further configured to store the program in the memory. The processor may be configured to store a first identification for the program. The processor may be further configured to execute at least part of the program. The program may be configured to generate a first request for the developer credentials for the program. The first request may include the first identification. The processor may be configured to send the first request to a platform server configured to be in communication with the processor. The processor may be further configured to receive the developer credentials from the platform server. The processor may be further configured to execute the program using the developer credentials to generate a second request. The second request may include the first identification and the developer credentials. The processor may be configured to send the second request to a service server different from the platform server.

In one example, a method for operating a device to receive developer credentials for a program is generally described. The method may include, by a processor, storing the program in a memory. The method may include storing a first identification for the program in the memory. The method may include executing at least part of the program. The program may be configured to generate a first request for the developer credentials for the program. The first request may include the first identification. The method may include sending the first request to a platform server configured in communication with the processor. The method may further include receiving the developer credentials from the platform server. The method may include executing the program using the first identification and the developer credentials to generate a second request. The second request may include the developer credentials. The method may include sending the second request to a service server different from the platform server.

In one example, a system configured to provide developer credentials to a device is generally described. The system may include a device, and a platform server. The device may include a processor and a memory. The platform server may be configured to be in communication with the device. The processor may be configured to store the program in the memory. The processor may be configured to store a first identification for the program in the memory. The processor may be configured to execute at least part of the program. The processor may be configured to generate a first request for the developer credentials for the program. The first request may include the first identification. The processor may be configured to send the first request to the platform server. The platform server may be configured to receive the first request and send the developer credentials in response. The processor may be configured to receive the developer credentials from the platform server. The processor may be configured to execute the program using the first identification and the developer credentials to generate a second request. The second request may include the developer credentials. The processor may be configured to send the second request to a service server different from the platform server.

In one example, a system configured to provide developer credentials to a device is generally described. The system may include a developer device, a user device, and a platform service. The developer device may be configured to send a registration request to a service server. The registration request may relate to a program. The developer device may be configured to receive a program identification for the program from the service server. The developer device may be configured to receive a service identification of the service server from the service server. The user device may be configured to be in communication with the developer device. The user device may include a processor and a memory. The platform server may be configured to be in communication with the user device. The processor may be configured to store the program, the program identification, and the service identification in the memory. The processor may be configured to execute at least part of the program. The program may be configured to generate a first request for the developer credentials for the program. The first request may include the program identification and the service identification. The processor may be configured to send the first request to the platform server. The platform server may be configured to receive the first request and send the developer credentials in response. The processor may be further configured to receive the developer credentials from the platform server. The processor may be configured to execute the program using the program identification, the service identification, and the developer credentials to generate a second request. The second request may include the developer credentials. The processor may be configured to send the second request to a service server different from the platform server.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 illustrates some example systems that can be utilized to implement securitization of developer credentials;

FIG. 2 illustrates some example systems that can be utilized to implement securitization of developer credentials;

FIG. 3 illustrates some example systems that can be utilized to implement securitization of developer credentials;

FIG. 4 illustrates some example systems that can be utilized to implement securitization of developer credentials;

FIG. 5 depicts a flow diagram for example processes for implementing securitization of developer credentials;

FIG. 6 illustrates computer program products configured to implement securitization of developer credentials; and

FIG. 7 is a block diagram illustrating an example computing device that is arranged to implement securitization of developer credentials;

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and computer program products related to securitization of developer credentials.

Briefly stated, technologies are generally described for systems and methods configured to provide developer credentials to a device. The developer device may be configured to send a registration request relating to a program to a service server. In response, the developer device may receive first information. A processor in a user device may be configured to store the program and the first information. The processor may execute at least part of the program to send a first request, including the first information, to a platform server. The processor may be further configured to receive second information in response. The processor may execute the program using the first and second information to generate a second request. The second request may include the second information and may be sent to a service server different from the platform server.

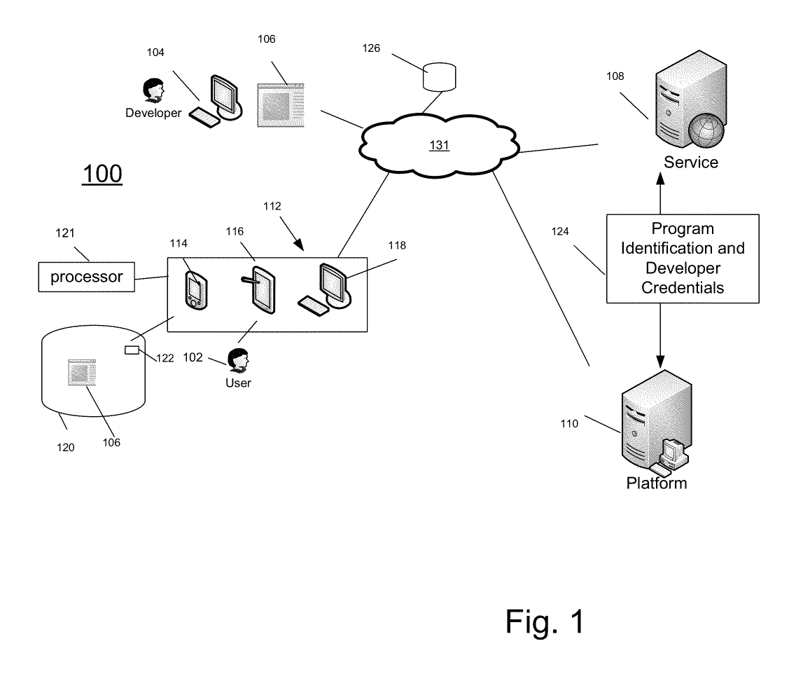

FIG. 1 illustrates some example systems that can be utilized to implement securitization of developer credentials in accordance with at least some embodiments described herein. A system 100 may include a developer device 104, a service server 108, a platform server 110, and/or a user device 112, all configured to be in communication over a network 131. Communication over network 130 may be encrypted using SSL (secure sockets layer) encryption and/or mutually authenticated SSL encryption. User device 122 may be capable of being used by a user 102. User device 122 may be, for example, a mobile phone 114, a tablet device 116, and/or a computer 118. User device 112 may include a processor 121 and may be configured to be in communication with a memory 120 including instructions 122. User device 112 and platform server 110 may both be controlled by the same platform such as APPLE, MICROSOFT, GOOGLE, etc.

As discussed in more detail below, a developer may use a developer device 104 to generate a program 106 and store program 106 in memory 126. Processor 121 may generate a request for a copy of program 106. Processor 121 may send the request over network 131, and receive and store program 106 in memory 120 in response to the request. Memory 126 may make program 106 available for user devices 112 to access. For example, memory 126 may be an application store. Program 106 may use services available through service server 108. For example, service server 108 may provide services for program 106 such as AMAZON AWS, TWILLIO, FACEBOOK, etc. Such services may be controlled by an account relating to a developer who may use developer device 104. For example, the developer may have one or more accounts with service server 108. Service server 108 may require that developer credentials relating to the developer be provided to service server 108 before services are provided for program 106. Service server 108 may exchange program identification and developer credentials 124 with platform server 110. The exchange of program identification and developer credentials 124 between services server 108 and platform server 110 may allow program 106 to use services of service server 108 while securing developer credentials relating to the developer.

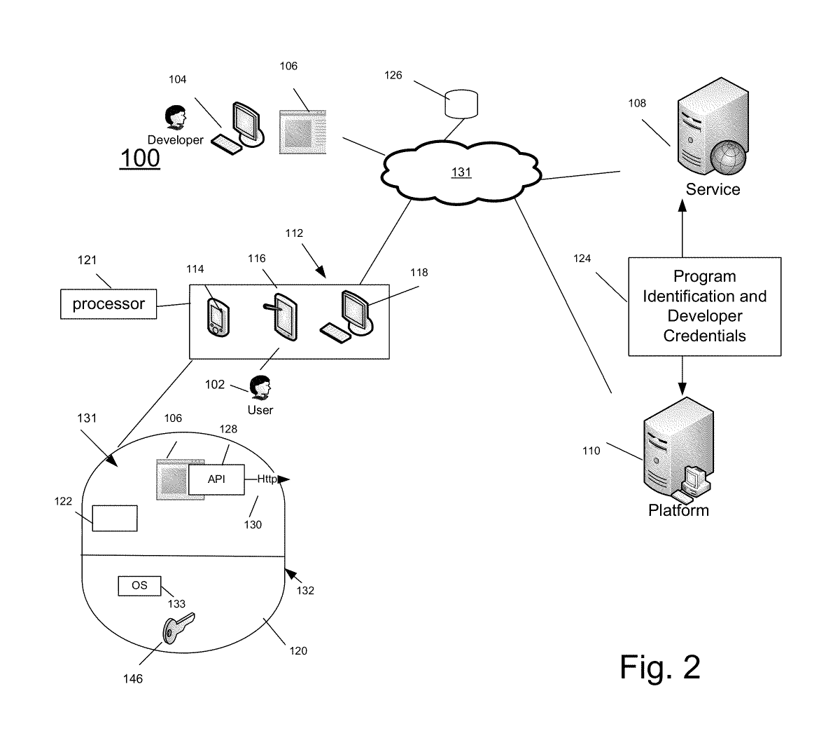

FIG. 2 illustrates an example system that can be utilized to implement securitization of developer credentials in accordance with at least some embodiments described herein. Those components in FIG. 2 that are labeled identically to components of FIG. 1 will not be described again for the purposes of clarity.

Program 106 may include an application programming interface (API) 128 configured to generate an http (hypertext transfer protocol) request 130. Http request 130 may be an application call over network 131 to access information and/or take action using services from service server 108. Data stored in memory 120 may be stored in different access layers, where each layer has different accessibility to user 102 and to functions on user device 112. For example, program 106 may be stored in an application layer 131 which may be accessible to user 102. An operating system (OS) layer 132 may have access to hardware in user device 112 and may be generally inaccessible to user 102. OS layer 132 may include an operating system 133. OS layer 132 may further include a keystore 146. A platform running user device 112 and platform server 110 may include keystore 146 in OS layer 132. Keystore 146 may be controlled by operating system 133. As keystore 146 is in operating system layer 132 and controlled by operating system 133, keystore 146 may be very difficult to be accessed by a user. Keystore 146 may be used to store developer credentials for program 106 as is explained in more detail below.

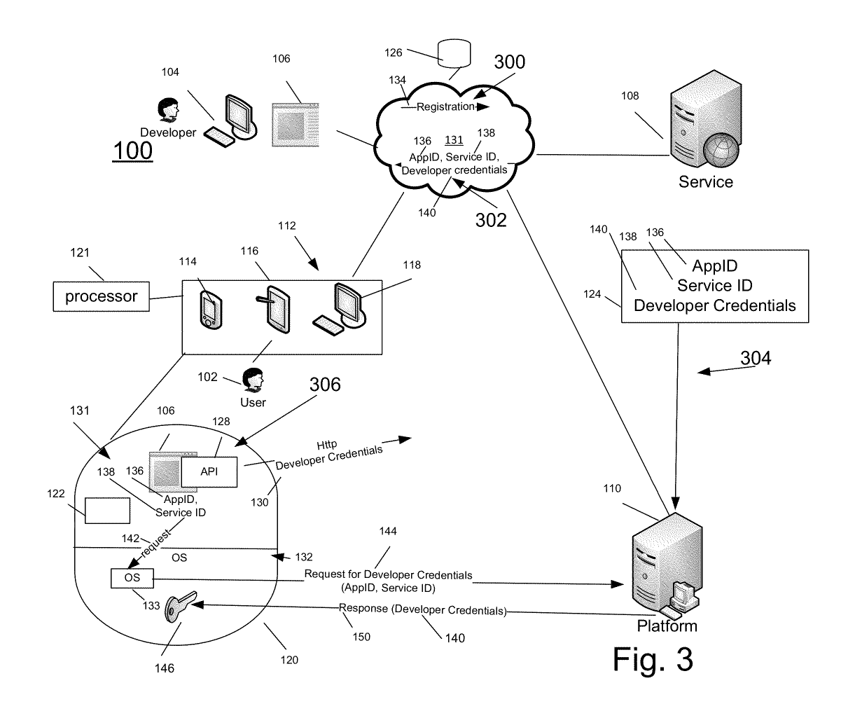

FIG. 3 illustrates an example system that can be utilized to implement securitization of developer credentials in accordance with at least some embodiments described herein. Those components in FIG. 3 that are labeled identically to components of FIGS. 1 and 2 will not be described again for the purposes of clarity.

In one example operation, at 300, developer device 104 may send a registration request 134 to service server 108 to register program 106. For example, registration request 134 may identify the developer or developer device 104 and program 106. Registration request 134 may further include a request for service server 108 to provide program identification and developer credentials 124 in response to registration request 134. In response to registration request 134, at 302, service server 108 may provide identification for program 106 including an application identifier (“AppID”) 136, a service identifier (“Service ID”) 138, and/or developer credentials 140. Application identifier 136 may correspond to program 106. Service identifier 138 may correspond to a service provided by service server 108. Service identifier 138 may be unique to program 106 and/or the developer or developer device 104. Developer identification 140 may be credentials associated with the developer or developer device 104 for program 106 using services provided by service server 108.

After registration, at 304, either developer device 104 or service server 108 may send program identification and developer credentials 124 to platform server 110. Program identification and developer credentials 124 may include application identification 136, service identification 138 and program identification and developer identification credentials 124. For example, service server 108 may offer integration with platform server 110 and may securely provide program identification and developer credentials 124. In another example, developer device 104 may send program identification and developer credentials 124 to platform server 110 such as through a platform operation developer portal.

Thereafter, at 306, user device 112 may acquire program 106 such as by downloading program 106 from memory 126. Program 106 may be securely signed by developer device 104 and authenticated by operating system 133. Program 106 may include application identifier 136 and service identifier 138 but not developer credentials 140. Program 106 may generate a request 142 requesting that operating system 133, in turn, generate a request 144 requesting developer credentials 140. For example, program 106 may generate request 142 using a software developer kit provided by the platform running operating system 133. Request 144 may be sent from operating system 133 to platform server 110. Request 144 may include application identification 136 and service identification 138.

In response to request 144, platform server 110 may send response 150, including developer credentials 140, to operating system 133. Operating system 133 may store developer credentials 140 in keystore 146. Operating system 133 may pass developer credentials 140 to program 106 using, for example, public key encryption. Program 106 may then generate http request 130 including developer credentials 140. Program 106 may send request 130 to service server 108. In response to request 130, service server 108 may allow program 106 to use services of service server 108.

In an example, developer credentials 140 may be stored in keystore 146. Developer credentials 140 may set by operating system 133 to delete or become otherwise inaccessible when a session including program 106 terminates. In another example, developer credentials 140 may be sent to user device 112 just prior to http request 130—so that developer identification credentials are not stored in keystore 146.

As operating system 133 and platform operating server 110 may be controlled by the same platform, a secure communication may be realized. Developers need not place developer credentials in the binary of program 106. Developer credentials may be easily changed and updated without requiring the developer to update each instance of program 106.

In some examples, request 142 may include a request for developer credentials for some, but not all, attributes of program 106. In these examples, response 150 may include credentials effective to allow some, but not all, of the services available to the developer or developer device 104 from service server 108.

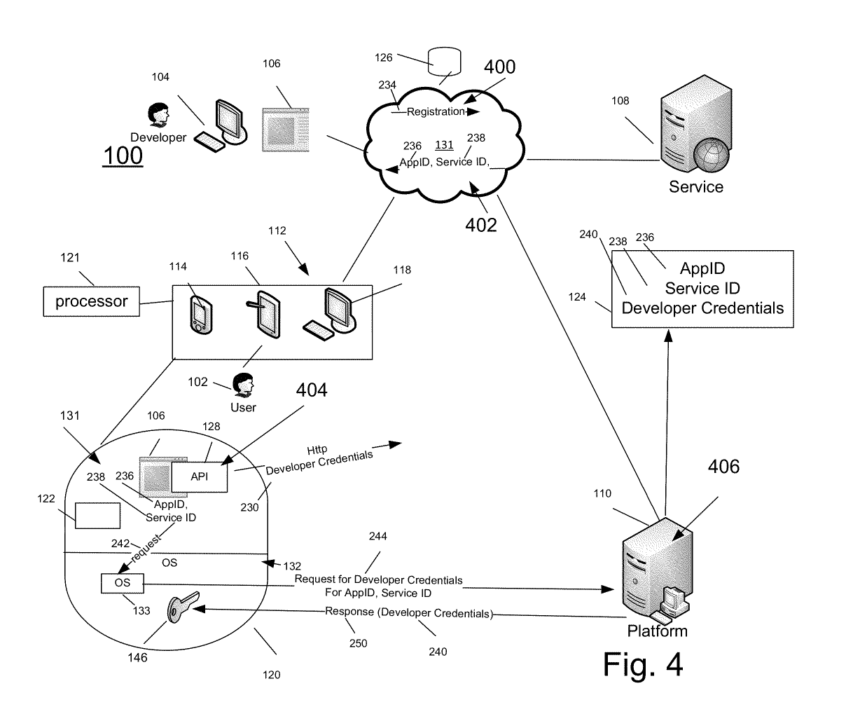

FIG. 4 illustrates an example system that can be utilized to implement securitization of developer credentials in accordance with at least some embodiments described herein. Those components in FIG. 4 that are labeled identically to components of FIGS. 1, 2 and 3 will not be described again for the purposes of clarity.

In one example operation, at 400, developer device 104 may send a registration request 234 to service server 108. For example, registration request 234 may identify the developer or developer device 104 and program 106. Registration request 134 may further include a request for service server 108 to provide identification information for program 106 and the developer or developer device 104 in response to registration request 134. In response to registration request 234, at 402, service server 108 may provide identification for program 106 including an application identifier (“AppID”) 236, and/or a service identifier (“Service ID”) 238. Service identifier 238 may be unique to program 106. Application identifier 236 may correspond to program 106. Service identifier 238 may correspond to a service provided by service server 108. Service identifier 238 may be unique to program 106 and/or the developer or developer device 104.

Thereafter, at 404, user 102 may acquire program 106 such as by downloading program 106 from memory 126. Program 106 may be securely signed by developer device 104 and authenticated by operating system 133. Program 106 may include application identifier 236 and service identifier 238. Program 106 may generate a request 242 requesting that operating system 133, in turn, generate a request 244 requesting developer credentials 140. For example, program 106 may generate request 242 using a software developer kit provided by the platform running operating system 133. Request 244 may be sent from operating system 133 to platform server 110. Request 244 may include application identification 236 and service identification 238.

In response to request 244, at 406, platform server 110 may generate developer credentials 240. Platform server 110 may send program identification and developer credentials 124 to service server 108. Program identification and developer credentials 124 may include application identification 236, service identification 238, and/or developer credentials 240. Platform server 110 may also generate response 250 including developer credentials 240 and send response 250 to operating system 133. Operating system 133 may store developer credentials 240 in keystore 146. Operating system 133 may pass developer credentials 240 to program 106 using, for example, public key encryption. Program 106 may then generate http request 230 including developer identification credentials 240. Program 106 may send request 230 to service server 108. In response to request 230, service server 108 may allow program 106 to use services of service server 108.

Developer credentials 240 may be generated once and may be used for each instance of program 106 from the developer or developer device 104. In another example, developer credentials 240 may be uniquely generated for each instance of program 106 and user device 112, so that device specific credentials may be generated. In examples where developer credentials 240 are unique to the instance of program 106, an extra layer of security may be provided. For example, service server 108 may be able to detect over a threshold number of requests including developer identification credentials from a specific device. Service server 108 may then deactivate or limit usage to that particular developer credential. Fraud may be detected more easily.

In some examples, request 242 may include a request for developer credentials for some, but not all, attributes of program 106. In this example, response 250 may include credentials effective to allow some, but not all, of the services available to the developer or developer device 104 from service server 108.

In an example, developer credentials 240 may be stored in keystore 146. Developer credentials 240 may set by operating system 133 to delete or become otherwise inaccessible when a session including program 106 terminates. In another example, developer credentials 240 may be sent to user device 112 just prior to http request 230—so that developer credentials are not stored in keystore 146.

Among other potential benefits, a system in accordance with the disclosure may allow a developer to effectively secure his credentials from users while still allowing users to access the developer's account from a third party service. The system can avoid hackers acquiring developer credentials through an application and then using those credentials outside of applications. Developers need not place credentials inside applications where they may be found. A better developer platform solution may be realized. Credentials may be stored in a memory of a user device and thus may be very difficult to hack. Credentials may be provided right before a request to a third party service, and may be created for one instance of a program and/or may last a defined period of time.

Developers may still be accurately charged for the services provided by the service server. Developers can easily change their credentials as the credentials need not be part of a program's binary. As such, developers can change their credentials without notifying users of the program. Multiple programs may be created with different credentials provided for different levels of access for the third party service.

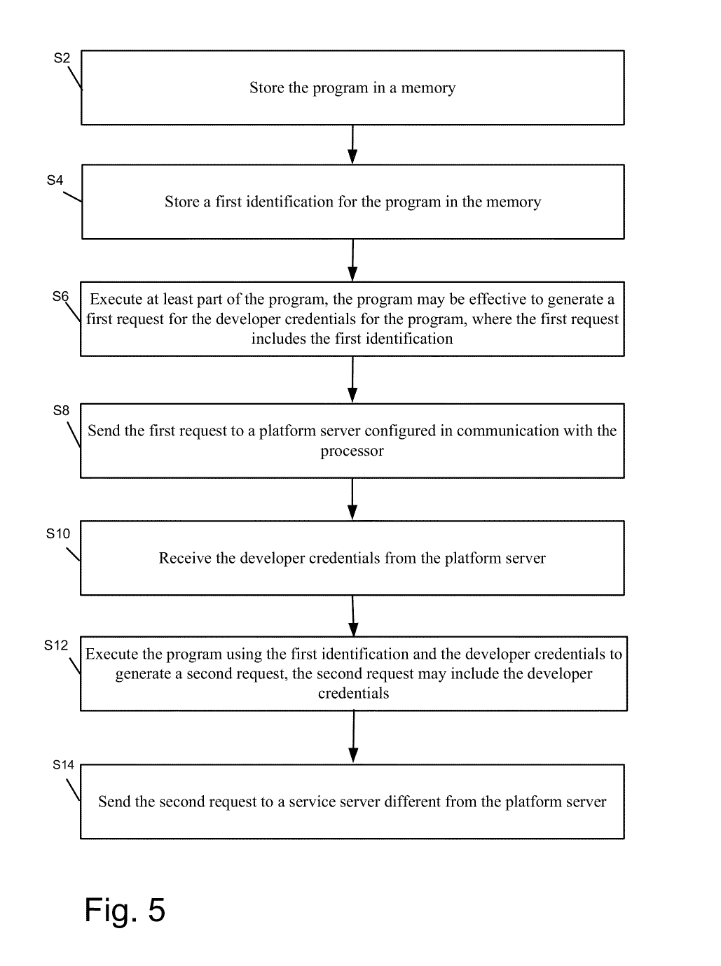

FIG. 5 depicts a flow diagram for example processes for implementing securitization of developer credentials in accordance with at least some embodiments described herein. The process in FIG. 5 could be implemented using, for example, system 100 discussed above. An example process of a method for operating a device to receive developer credentials for a program may include one or more operations, actions, or functions as illustrated by one or more of blocks S2, S4, S6, S8, S10, S12 and/or S14. Although illustrated as discrete blocks, various blocks may be divided into additional blocks, combined into fewer blocks, or eliminated, depending on the desired implementation.

Processing may begin at block S2, “Store the program in a memory.” At block S2, a processor in a user device may store a program in a memory. The memory may include an operating system. The operating system may include an application layer and an operating system layer and the program may be stored in the application layer.

Processing may continue from block S2 to block S4, “Store a first identification for the program in the memory.” At block S2, the processor may store a first identification for the program, such as a program identification and/or a service identification relating to a service server effective to provide services for the program.

Processing may continue from block S4 to block S6, “Execute at least part of the program, the program may be effective to generate a first request for the developer credentials for the program, where the first request includes the first identification.” At block S6, the processor may be effective to execute the program to generate a first request. The first request may include the first identification.

Processing may continue from block S6 to block S8, “Send the first request to a platform server configured in communication with the processor.” At block S8, the processor may send the first request to a platform server. The platform server may operate on the same platform as the processor. The first request may be sent from the operating system of the processor.

Processing may continue from block S8 to block S10, “Receive the developer credentials from the platform server.” At block S10, the processor may receive the developer credentials from the platform server. The processor may receive the developer credentials in the operating system layer. The processor may delete the developer credentials upon termination of the program.

Processing may continue from block S10 to block S12, “Execute the program using the first identification and the developer credentials to generate a second request, the second request may include the first identification and the developer credentials.” At block S12, the processor may execute the program using the first identification and the developer credentials to generate the second request. The processor may pass the developer credentials upon generation of the second request.

Processing may continue from block S12 to block S14, “Send the second request to a service server different from the platform server.” At block S14, the first device may send the second request to a service server.

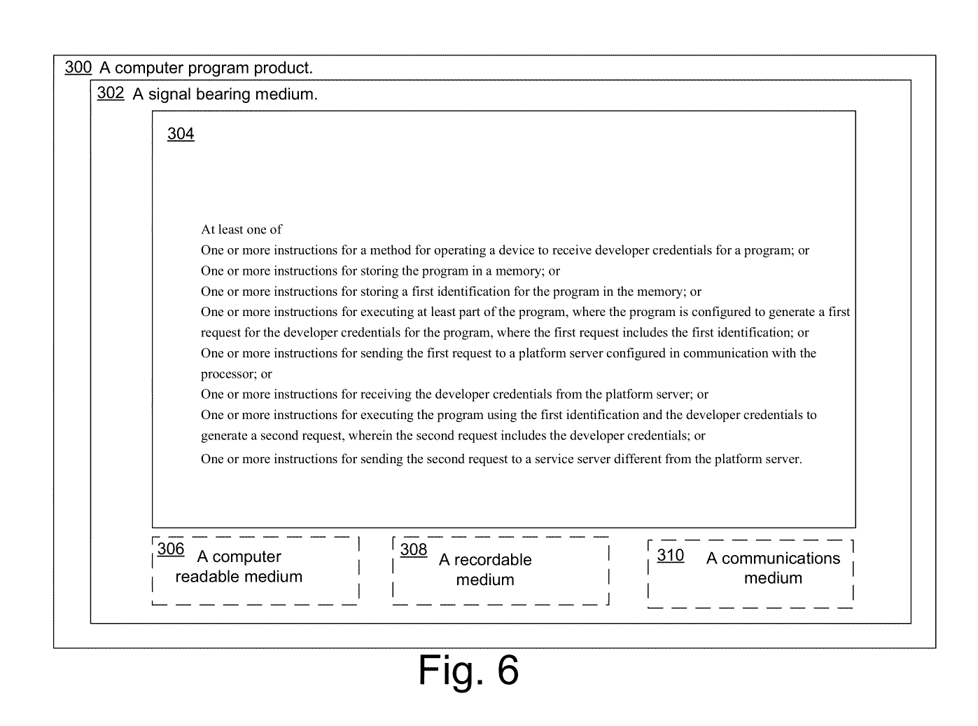

FIG. 6 illustrates computer program products 300 effective to implement securitization of developer credentials in accordance with at least some embodiments described herein. Program product 300 may include a signal bearing medium 302. Signal bearing medium 302 may include one or more instructions 304 that, when executed by, for example, a processor, may provide the functionality described above with respect to FIGS. 1-5. Thus, for example, referring to system 100, processor 121 may undertake one or more of the blocks shown in FIG. 6 in response to instructions 304 conveyed to the system 100 by medium 302.

In some implementations, signal bearing medium 302 may encompass a computer-readable medium 306, such as, but not limited to, a hard disk drive, a Compact Disc (CD), a Digital Video Disk (DVD), a digital tape, memory, etc. In some implementations, signal bearing medium 302 may encompass a recordable medium 308, such as, but not limited to, memory, read/write (R/W) CDs, R/W DVDs, etc. In some implementations, signal bearing medium 302 may encompass a communications medium 310, such as, but not limited to, a digital and/or an analog communication medium (e.g., a fiber optic cable, a waveguide, a wired communications link, a wireless communication link, etc.). Thus, for example, program product 300 may be conveyed to one or more modules of the system 100 by an RF signal bearing medium 302, where the signal bearing medium 302 is conveyed by a wireless communications medium 310 (e.g., a wireless communications medium conforming with the IEEE 802.11 standard).

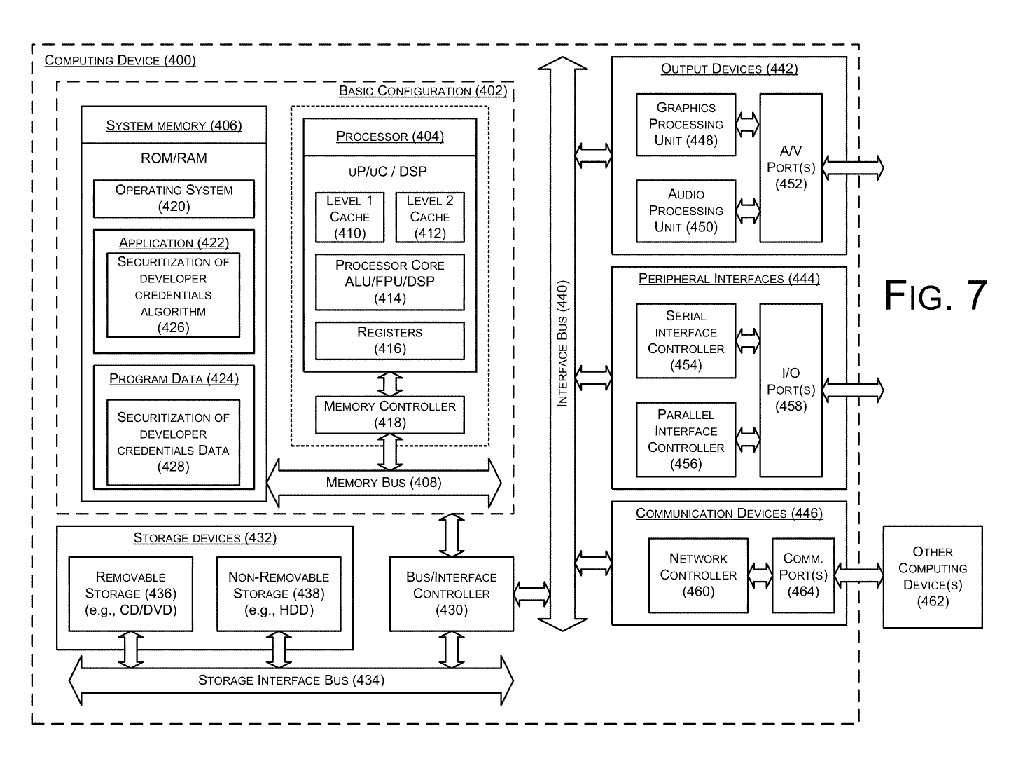

FIG. 7 is a block diagram illustrating an example computing device 400 that is arranged to implement securitization of developer credentials arranged in accordance with at least some embodiments described herein. In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424.

Application 422 and/or operating system 420 may include a securitization of developer credentials algorithm 426 that is arranged to perform the functions as described herein including those described previously with respect to FIGS. 1-6. Program data 424 may include securitization of developer credentials data 428 that may be useful for implementing securitization of developer credentials as is described herein. In some embodiments, application 422 and/or operating system 420 may be arranged to operate with program data 424 on operating system 420 such that securitization of developer credentials may be provided. This described basic configuration 402 is illustrated in FIG. 4 by those components within the inner dashed line.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A device configured to receive developer credentials for a program, the device comprising:
a memory;
a processor configured to be in communication with the memory, wherein the processor is further configured to:
store the program in the memory;
store a first identification for the program;
execute at least part of the program, where the program is configured to generate a first request for the developer credentials for the program, where the first request includes the first identification, and where the developer credentials are credentials to use a service from a service server;
send the first request to a platform server configured to be in communication with the processor;
receive the developer credentials from the platform server;
execute the program using the first identification and the developer credentials to generate a second request, wherein the second request includes the developer credentials; and
send the second request to the service server different from the platform server.

2. The device of claim 1, wherein the processor is further configured to execute the program with use of services from the service server.

3. The device of claim 1, wherein the program has attributes and, with the developer credentials, the processor is further configured to execute less than all of the attributes of the program with use of services from the service server.

4. The device of claim 1, wherein, with the developer credentials, the processor is further configured to execute the program with use of less than all of the services from the service server.

5. The device of claim 1, wherein the developer credentials are unique to the device.

6. The device of claim 1, wherein the developer credentials are unique to the program.

7. The device of claim 1, wherein:
the memory includes an operating system;
the program is configured to generate the first request for the developer credentials; and
the operating system is configured to send the first request to the platform server.

8. The device of claim 1, wherein:
the memory includes an application layer and an operating system layer; and
the processor is configured to receive the developer credentials in the operating system layer.

9. The device of claim 1, wherein:
the memory includes an application layer and an operating system layer; and the processor is configured to:
store the developer credentials in the operating system layer; and
delete the developer credentials upon termination of the program.

10. The device of claim 1, wherein:
the memory includes an application layer and an operating system layer; and
the processor is configured to receive the developer credentials in the operating system layer; and
upon generation of the second request, pass the developer credentials to the program.

11. The device of claim 1, wherein the first identification includes an application identifier for the program and a service identification for the service server.

12. A method for operating a device to receive developer credentials for a program, the method comprising, by a processor:
storing the program in a memory;
storing a first identification for the program in the memory;
executing at least part of the program, where the program is configured to generate a first request for the developer credentials for the program, where the first request includes the first identification, and where the developer credentials are credentials to use a service from a service server;
sending the first request to a platform server configured in communication with the processor;
receiving the developer credentials from the platform server;
executing the program using the first identification and the developer credentials to generate a second request, wherein the second request includes the developer credentials; and
sending the second request to the service server different from the platform server.

13. (canceled)

14. The method of claim 12, wherein the memory includes an application layer and an operating system layer and the method further comprises receiving the developer credentials in the operating system layer.

15. The method of claim 12, wherein the memory includes an application layer and an operating system layer and the method further comprises:
storing the developer credentials in the operating system layer; and
deleting the developer credentials upon termination of the program.

16. The method of claim 12, wherein the memory includes an application layer and an operating system layer, and the method further comprises:
receiving the developer credentials in the operating system layer; and
upon generation of the second request, passing the developer credentials to the program.

17. (canceled)

18. A system configured to provide developer credentials to a device, the system comprising:
a device, wherein the device includes a processor and a memory; and
a platform server configured to be in communication with the device;
wherein the processor is configured to:
store the program in the memory;
store a first identification for the program in the memory;
execute at least part of the program, where the program is configured to generate a first request for the developer credentials for the program, where the first request includes the first identification, and where the developer credentials are credentials to use a service from a service server; and
send the first request to the platform server;
the platform server is configured to receive the first request and send the developer credentials in response;
the processor is further configured to:
receive the developer credentials from the platform server;
execute the program using the first identification and the developer credentials to generate a second request, wherein the second request includes the developer credentials; and
send the second request to the service server different from the platform server.

19. (canceled)

20. (canceled)

21. (canceled)

22. The system of claim 18, wherein:
the device and the platform server are both operated by the same platform;
the memory includes an application layer and an operating system layer; and
the processor is configured to receive the developer credentials in the operating system layer.

23. (canceled)

24. (canceled)

25. A system configured to provide developer credentials to a device, the system comprising:
a developer device, the developer device configured to:
send a registration request to a service server, where the registration request relates to a program;
receive a program identification for the program from the service server; and
receive a service identification of the service server from the service server;
a user device, wherein the user device includes a processor and a memory;
a platform server configured to be in communication with the user device;
wherein the processor is configured to:
store the program, the program identification, and the service identification in the memory;
execute at least part of the program, where the program is configured to generate a first request for the developer credentials for the program, where the first request includes the program identification and the service identification, and where the developer credentials are credentials to use a service from the service server; and
send the first request to the platform server;
the platform server is further configured to receive the first request and send the developer credentials in response;
the processor is further configured to:
receive the developer credentials from the platform server;
execute the program using the program identification, the service identification, and the developer credentials to generate a second request, wherein the second request includes the developer credentials; and
send the second request to the service server different from the platform server.

26. The system of claim 25, wherein, in response to the registration request:
the developer device is further configured to receive the developer credentials; and
the platform server is further configured to receive the program identification, the service identification, and the developer credentials.

27. The system of claim 25, wherein the platform server is further configured to:
receive the first request;
in response to the first request, generate the developer credentials;
send the developer credentials to the user device; and
send the developer credentials, the program identification and the service identification to the service server.

28. The system of claim 25, wherein the user device and the platform server are both operated by the same platform.

29. (canceled)

30. (canceled)

31. (canceled)

32. (canceled)

33. (canceled)
